(19) United States
(12) Patent Application Publication
(10) Pub. No.: US 2016/0131484 A1
(43) Pub. Date: May 12, 2016

(54) SYSTEM AND METHOD FOR DEVICE POSITION CLASSIFICATION

(71) Applicant: InvenSense, Inc., San Jose, CA (US)

(72) Inventor: Hemabh Shekhar, San Jose, CA (US)

(21) Appl. No.: 14/537,568

(22) Filed: Nov. 10, 2014

(51) Int. Cl. G01C 21/16

(52) U.S. Cl. CPC G01C 21/165

(57) ABSTRACT

A system and method for classifying a position of a device may include processing one or more respective signal characteristics of one or more signals indicative of device orientation to determine a position of a device relative to a user. In a non-limiting example, various aspects of this disclosure include analyzing, over time, one or more characteristics of a first signal indicative of the alignment of a first device axis with a reference direction and one or more characteristics of a second signal indicative of the alignment of a second device axis with the known direction, and determining the position of the device based at least in part on such analysis. One or more analyzed signals may, for example, correspond to and/or be derived from MEMS sensor signals.

### CROSS-REFERENCE TO RELATED APPLICATIONS/INCORPORATION BY REFERENCE

U.S. Pat. No. 7,104,129 is hereby incorporated herein by reference in its entirety. U.S. patent application Ser. No. 12/106,921, filed Apr. 21, 2008, is hereby incorporated herein by reference in its entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND

Consumer devices do not classify device position, for example relative to a user, in an efficient and reliable manner. For example, hand-held and/or wearable consumer devices do not efficiently and reliably determine whether and/or how a device is being held or otherwise carried by a user. Further limitations and disadvantages of conventional and traditional approaches will become apparent to one of skill in the art, through comparison of such approaches with the disclosure as set forth in the remainder of this application with reference to the drawings.

### BRIEF DESCRIPTION OF SEVERAL VIEWS OF THE DRAWINGS

FIG. 1 shows a block diagram of an example electronic device comprising position classification capability, in accordance with various aspects of the present disclosure.

FIGS. 2A-2C show example signal plots, in accordance with various aspects of the present disclosure.

FIG. 3 shows a chart of two signal processing features, in accordance with various aspects of the present disclosure.

FIG. 4 shows an example processing system for determining a position of a device, in accordance with various aspects of the present disclosure.

FIG. 5 shows an example processing system for determining a position of a device, for example incorporating signal selection, in accordance with various aspects of the present disclosure.

FIG. 6 shows an example processing system for determining a position of a device, for example incorporating non-inertial sensor data, in accordance with various aspects of the present disclosure.

FIG. 7 shows an example processing system for determining a position of a device, for example incorporating orientation, in accordance with various aspects of the present disclosure.

FIG. 8 shows an example processing system for determining a position of a device, for example analyzing multiple characteristics of a signal, in accordance with various aspects of the present disclosure.

FIG. 9 shows an example processing system for determining a position of a device, for example analyzing one or more characteristics of a plurality of signals, in accordance with various aspects of the present disclosure.

FIG. 10 shows an example processing system for determining a position of a device, for example analyzing a first characteristic of a signal and a second characteristic of a plurality of signals, in accordance with various aspects of the present disclosure.

FIG. 11 shows an example processing system for determining a position of a device, for example analyzing a first characteristic of a plurality of signals and a second characteristic of a plurality of signals, in accordance with various aspects of the present disclosure.

FIG. 12 shows an example processing system for determining a position of a device, for example analyzing a first characteristic of a selectable first set of signals and a second characteristic of a selectable second set of signals, in accordance with various aspects of the present disclosure.

FIG. 13 shows an example processing system for determining a position of a device, for example analyzing a first characteristic of a selectable first set of signals and a second characteristic of a selectable second set of signals and non-inertial sensor data, in accordance with various aspects of the present disclosure.

### SUMMARY

Various aspects of this disclosure comprise processing one or more respective signal characteristics of one or more signals indicative of device orientation to determine a position of a device relative to a user that is in motion. In a non-limiting example, various aspects of this disclosure comprise analyzing, over time, one or more characteristics of a first signal indicative of the alignment of a first device axis with a reference direction and one or more characteristics of a second signal indicative of the alignment of a second device axis with the known direction, and determining the position of the device based at least in part on such analysis. One or more analyzed signals may, for example, correspond to and/or be derived from MEMS sensor signals.

### DETAILED DESCRIPTION OF VARIOUS ASPECTS OF THE DISCLOSURE

The following discussion presents various aspects of the present disclosure by providing various examples thereof. Such examples are non-limiting, and thus the scope of various aspects of the present disclosure should not necessarily be limited by any particular characteristics of the provided examples. In the following discussion, the phrases “for example” and “e.g.” and “exemplary” are non-limiting and are generally synonymous with “by way of example and not limitation,” “for example and not limitation,” and the like.

The following discussion may at times utilize the phrase “A and/or B.” Such phrase should be understood to mean just A, or just B, or both A and B. Similarly, the phrase “A, B, and/or C” should be understood to mean just A, just B, just C, A and B, A and C, B and C, or all of A and B and C.

The following discussion may at times utilize the phrases “operable to,” “operates to,” and the like in discussing functionality performed by particular hardware, including hardware operating in accordance with software instructions. The phrases “operates to,” “is operable to,” and the like include “operates when enabled to.” For example, a module that operates to perform a particular operation, but only after receiving a signal to enable such operation, is included by the phrases “operates to,” “is operable to,” and the like.

The following discussion may at times refer to various system or device functional modules. It should be understood that the functional modules were selected for illustrative clarity and not necessarily for providing distinctly separate hardware and/or software modules. For example, any one or more of the modules discussed herein may be implemented by shared hardware, including for example a shared processor. Also for example, any one or more of the modules discussed herein may share software portions, including for example subroutines. Additionally for example, any one or more of the modules discussed herein may be implemented with independent dedicated hardware and/or software. Accordingly, the scope of various aspects of this disclosure should not be limited by arbitrary boundaries between modules unless explicitly claimed. Additionally, it should be understood that when the discussion herein refers to a module performing a function, the discussion is generally referring to either a pure hardware module implementation and/or a processor operating in accordance with software. Such software may, for example, be stored on a non-transitory machine-readable medium.

In various example embodiments discussed herein, a chip is defined to include at least one substrate typically formed from a semiconductor material. A single chip may for example be formed from multiple substrates, where the substrates are mechanically bonded and electrically connected to preserve the functionality. Multiple chip (or multi-chip) includes at least 2 substrates, wherein the 2 substrates are electrically connected, but do not require mechanical bonding.

A package provides electrical connection between the bond pads on the chip (or for example a multi-chip module) to a metal lead that can be soldered to a printed circuit board (or PCB). A package typically comprises a substrate and a cover. An Integrated Circuit (IC) substrate may refer to a silicon substrate with electrical circuits, typically CMOS circuits. A MEMS substrate provides mechanical support for the MEMS structure(s). The MEMS structural layer is attached to the MEMS substrate. The MEMS substrate is also referred to as handle substrate or handle wafer. In some embodiments, the handle substrate serves as a cap to the MEMS structure.

In the described embodiments, an electronic device incorporating a sensor may, for example, employ a motion tracking module also referred to as Motion Processing Unit (MPU) that includes at least one sensor in addition to electronic circuits. The at least one sensor may comprise any of a variety of sensors, such as for example a gyroscope, a compass, a magnetometer, an accelerometer, a microphone, a pressure sensor, a proximity sensor, a moisture sensor, a temperature sensor, a biometric sensor, or an ambient light sensor, among others known in the art.

Some embodiments may, for example, comprise an accelerometer, gyroscope, and magnetometer or other compass technology, which each provide a measurement along three axes that are orthogonal relative to each other, and may be referred to as a 9-axis device. Other embodiments may, for example, comprise an accelerometer, gyroscope, compass, and pressure sensor, and may be referred to as a 10-axis device. Other embodiments may not include all the sensors or may provide measurements along one or more axes.

The sensors may, for example, be formed on a first substrate. Various embodiments may, for example, include solid-state sensors and/or any other type of sensors. The electronic circuits in the MPU may, for example, receive measurement outputs from the one or more sensors. In various embodiments, the electronic circuits process the sensor data. The electronic circuits may, for example, be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package. (e.g., both attached to a common packaging substrate or other material). In other embodiments, the sensors may, for example, be formed on different respective substrates (e.g., all attached to a common packaging substrate or other material).

In an example embodiment, the first substrate is attached to the second substrate through wafer bonding, as described in commonly owned U.S. Pat. No. 7,104,129, which is hereby incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Motion data refers to processed raw data. Processing may, for example, comprise applying a sensor fusion algorithm or applying any other algorithm. In the case of a sensor fusion algorithm, data from one or more sensors may be combined and/or processed to provide an orientation of the device. In the described embodiments, an MPU may include processors, memory, control logic and sensors among structures.

For various device operational characteristics, it may be beneficial to know how the device is presently being used or carried. For example, in a mobile telephone example, it may be beneficial for the operating system of the telephone to know how the user is utilizing the phone while walking. In particular, it may be beneficial for the operating system of the telephone to know whether the phone is presently in a user's pocket while the user is walking, whether the phone is being held in a user's hand in front of the user while the user is walking, whether the phone is being held in a hand at the user's side while the user is walking, etc. For example, when a phone is being carried in a user's pocket, the operating system may safely turn off various phone functionality (e.g., visual display functionality, positioning functionality, etc.) and may also, for example, turn up a volume of audio notifications. Also for example, when a phone is being carried by a user out in front of the user, the operating system may turn on or keep on the visual display and/or other functionality, and may also turn down a volume of audio notifications.

Accordingly, various aspects of this disclosure comprise processing one or more respective signal characteristics of one or more signals indicative of device orientation to determine a position of a device relative to a user (e.g., a user that is moving). In a non-limiting example, various aspects of this disclosure comprise analyzing, over time, one or more characteristics of a first signal indicative of the alignment of a first device axis with a first reference direction and one or more characteristics of a second signal indicative of the alignment of a second device axis with a second reference direction (e.g., where the first and second reference directions may be the same or different), and determining the position of the device based at least in part on such analysis. The position of the device may, for example, be determined in relation to the user of the device (e.g., in the user's pocket, in the user's hand at the user's side, in the user's hand held in front of the user, etc.). The discussion will now turn to discussing various aspects in view of the attached figures.

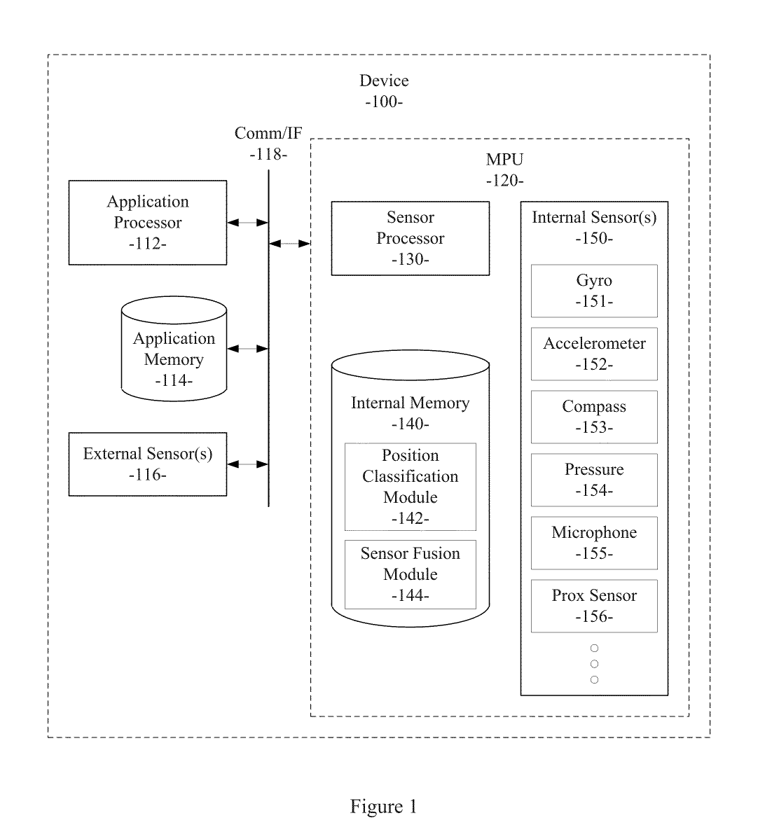

Turning first to FIG. 1, such figure shows a block diagram of an example electronic device 100 comprising position classification capability, in accordance with various aspects of the present disclosure. As will be appreciated, the device 100 may be implemented as a device or apparatus, such as a handheld and/or wearable device that can be moved in space by a user, and its motion and/or orientation in space therefore sensed. For example, such a handheld and/or wearable device may comprise a mobile phone (e.g., a cellular phone, a phone running on a local network, or any other telephone handset), wired telephone (e.g., a phone attached by a wire and/or optical tether), personal digital assistant (PDA), pedometer, personal activity and/or health monitoring device, video game player, video game controller, navigation device, mobile internet device (MID), personal navigation device (PND), digital still camera, digital video camera, binoculars, telephoto lens, portable music, video, or media player, remote control, or other handheld device, headset, eyeglasses, or a combination of one or more of these devices.

In some embodiments, the device 100 may be a self-contained device that comprises its own display and/or other user output devices in addition to the user input devices as described below. However, in other embodiments, the device 100 may function in conjunction with another portable device or a non-portable device such as a desktop computer, electronic tabletop device, server computer, smart phone, etc., which can communicate with the device 100, e.g., via network connections. The device 100 may, for example, be capable of communicating via a wired connection using any type of wire-based communication protocol (e.g., serial transmissions, parallel transmissions, packet-based data communications), wireless connection (e.g., electromagnetic radiation, infrared radiation or other wireless technology), or a combination of one or more wired connections and one or more wireless connections.

As shown, the example device 100 comprises an MPU 120, application (or host) processor 112, application (or host) memory 114, and may comprise one or more sensors, such as external sensor(s) 116. The application processor 112 may, for example, be configured to perform the various computations and operations involved with the general function of the device 100 (e.g., running applications, performing operating system functions, performing power management functionality, controlling user interface functionality for the device 100, etc.). The application processor 112 may, for example, be coupled to MPU 120 through a communication interface 118, which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent. The application memory 114 may, for example, comprise programs, drivers or other data that utilize information provided by the MPU 120. Details regarding example suitable configurations of the application (or host) processor 112 and MPU 120 may be found in co-pending, commonly owned U.S. patent application Ser. No. 12/106,921, filed Apr. 21, 2008, which is hereby incorporated herein by reference in its entirety.

In this example embodiment, the MPU 120 is shown to comprise a sensor processor 130, internal memory 140 and one or more internal sensors 150. The internal sensors 150 comprise a gyroscope 151, an accelerometer 152, a compass 153 (for example a magnetometer), a pressure sensor 154, a microphone 155, and a proximity sensor 156. Though not shown, the internal sensors 150 may comprise any of a variety of sensors, for example, a temperature sensor, light sensor, moisture sensor, biometric sensor, etc. All or some of the internal sensors 150 may, for example, be implemented as MEMS-based motion sensors, including inertial sensors such as a gyroscope or accelerometer, or an electromagnetic sensor such as a Hall effect or Lorentz field magnetometer. As desired, one or more of the internal sensors 150 may be configured to provide raw data output measured along three orthogonal axes or any equivalent structure. The internal memory 140 may store algorithms, routines or other instructions for processing data output by one or more of the internal sensors 120, including the position classification module 142 and sensor fusion module 144, as described in more detail herein. If provided, external sensor(s) 116 may comprise one or more sensors, such as accelerometers, gyroscopes, magnetometers, pressure sensors, microphones, proximity sensors, and ambient light sensors, biometric sensors, temperature sensors, and moisture sensors, among other sensors. As used herein, an internal sensor generally refers to a sensor implemented, for example using MEMS techniques, for integration with the MPU 120 into a single chip. Similarly, an external sensor as used herein generally refers to a sensor carried on-board the device 100 that is not integrated into the MPU 120.

Even though various embodiments may be described herein in the context of internal sensors implemented in the MPU 120, these techniques may be applied to a non-integrated sensor, such as an external sensor 116, and likewise position classification module 142 may be implemented using instructions stored in any available memory resource, such as for example the application memory 114, and may be executed using any available processor, such as for example the application processor 112. Still further, the functionality performed by the position classification module 142 may be implemented using any combination of hardware, firmware and software.

As will be appreciated, the application (or host) processor 112 and/or sensor processor 130 may be one or more microprocessors, central processing units (CPUs), microcontrollers or other processors, which run software programs for the device 100 and/or for other applications related to the functionality of the device 100. For example, different software application programs such as menu navigation software, games, camera function control, navigation software, and telephone, or a wide variety of other software and functional interfaces, can be provided. In some embodiments, multiple different applications can be provided on a single device 100, and in some of those embodiments, multiple applications can run simultaneously on the device 100. Multiple layers of software can, for example, be provided on a computer readable medium such as electronic memory or other storage medium such as hard disk, optical disk, flash drive, etc., for use with application processor 112 and sensor processor 130. For example, an operating system layer can be provided for the device 100 to control and manage system resources in real time, enable functions of application software and other layers, and interface application programs with other software and functions of the device 100. In various example embodiments, one or more motion algorithm layers may provide motion algorithms for lower-level processing of raw sensor data provided from internal or external sensors. Further, a sensor device driver layer may provide a software interface to the hardware sensors of the device 100. Some or all of these layers can be provided in the application memory 114 for access by the application processor 112, in internal memory 140 for access by the sensor processor 130, or in any other suitable architecture (e.g., including distributed architectures).

In some example embodiments, it will be recognized that the example architecture depicted in FIG. 1 may provide for position classification to be performed using the MPU 120 and might not require involvement of the application (or host) processor 112 and/or application memory 114. Such example embodiments may, for example, be implemented with one or more internal sensor sensors 150 on a single chip and/or a multi-chip. Moreover, as will be described below, the position classification techniques may be implemented using computationally efficient algorithms to reduce processing overhead and power consumption.

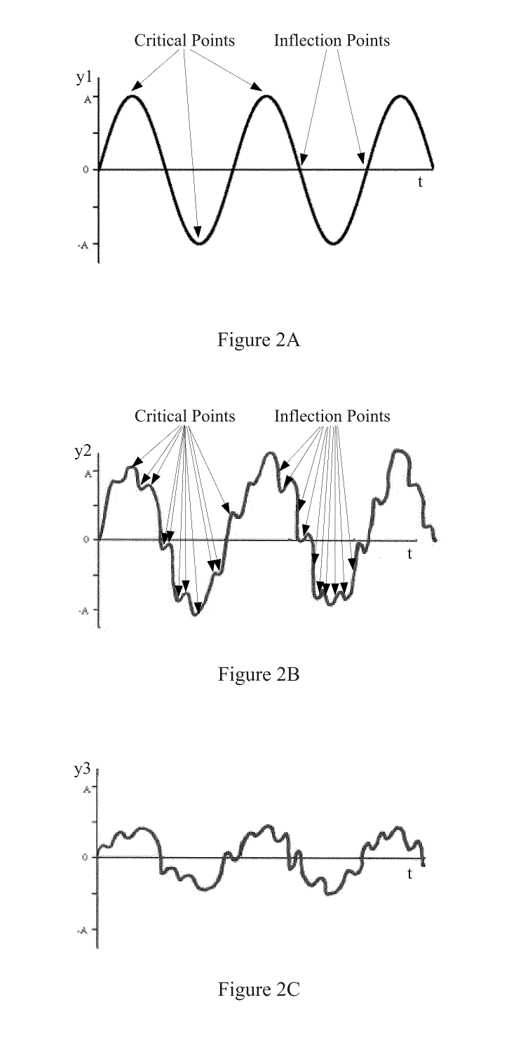

As mentioned herein, a position classification module may be implemented by a processor (e.g., the sensor processor 130) operating in accordance with software instructions (e.g., the position classification module 142 stored in the internal memory 140), or by a pure hardware solution. The discussion of FIGS. 2-13 will provide further example details of at least the operation of the sensor fusion software module 144 and/or the position classification module 142 (e.g., when executed by a processor such as the sensor processor 130). It should be understood that any or all of the functional modules discussed herein may be implemented in a pure hardware implementation and/or by a processor operating in accordance with software instructions. It should also be understood that any or all software instructions may be stored in a non-transitory computer-readable medium

Various aspects of this disclosure comprise determining or classifying a position of a device by, at least in part, analyzing transformation coefficients that are generally utilized to transform a position, vector, velocity, acceleration, etc., from a first coordinate system to a second coordinate system. Such a transformation may be generally performed by multiplying an input vector expressed in the first coordinate system by a transformation matrix. General transformation matrices comprise translation coefficients and rotation coefficients. For illustrative clarity, the discussion herein will focus on rotation coefficients. Note, however, that the scope of various aspects of this disclosure is not limited to rotation coefficients.

The rotational aspects of a transformation matrix may, for example, be expressed as a rotation matrix. In general, a rotation matrix (e.g., a direction cosine matrix or DCM) may be utilized to rotationally transform coordinates (e.g., of a vector, position, velocity, acceleration, force, etc.) expressed in a first coordinate system to coordinates expressed in a second coordinate system. For example, a direction cosine matrix R may look like:

$$R = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ]$$

In an example scenario in which a first vector A_{b} expresses coordinates of a point in a body (or device) coordinate system and a second vector A_{w} expresses coordinates of a point in a world (or inertial) coordinate system, the following equation may be used to determine A_{w} from A_{b}:

A_{w}=RA_{b}

The third row of the rotation matrix R may, for example, be generally concerned with determining the z-axis component of the world coordinate system, A_{w}^{z}, as a function of the matrix coefficients R₃₁, R₃₂, and R₃₃ multiplied by respective A_{b}^{x}, A_{b}^{y}, and A_{b}^{z} values of the body coordinate vector A_{b}, which are then summed.

For example R₃₃, which may also be referred to herein as g_{z}, is the extent to which the z axis of the body coordinate system is aligned with the z axis of the world coordinate system. In a mobile telephone scenario, the z axis in the body coordinate system may, for example, be defined as extending orthogonally from the face of the telephone. The z axis of the world coordinate system may, for example, be aligned with gravity and point upward from the ground. A value of R₃₃=1 means that the z axis in the body coordinate system is perfectly aligned with the z axis of the world coordinate system, and thus there is a 1-to-1 mapping.

Also for example R₃₂, which may also be referred to herein as g_{y}, is the extent to which the y axis of the body coordinate system is aligned with the z axis of the world coordinate system. In a telephone scenario, the y axis may, for example, be defined as extending out the top of the phone along the longitudinal axis of the phone. A value of R₃₂=1 means that the y axis in the body coordinate system is perfectly aligned with the z axis of the world coordinate system, and thus there is a 1-to-1 mapping.

Additionally for example R₃₁, which may also be referred to herein as gₓ, is the extent to which the x axis of the body coordinate system is aligned with the z axis of the world coordinate system. In a telephone scenario, the x axis may for example be defined as extending out the right side of the phone when looking at the face of the phone along the lateral axis of the phone. A value of R₃₁=1 means that the x axis in the body coordinate system is perfectly aligned with the z axis of the world coordinate system, and thus there is a 1-to-1 mapping.

As a last example, if R₃₁=0, R₃₂=1/sqrt(2), and R₃₃=1/sqrt(2), then:
1) The x axis of the body coordinate system is orthogonal to the z axis of the world coordinate system;
2) The y axis of the body coordinate system is 45° relative to the z axis of the world coordinate system; and
3) The z axis of the body coordinate system is 45° relative to the z axis of the world coordinate system.

The coefficients of the rotation matrix R express an instantaneous rotational relationship, but as a device moves, the coefficients change over time. In such a scenario, the matrix R coefficients may, for example, be updated on a periodic basis at an update rate that is implementation dependent (e.g., at a sensor update rate, at a user step rate, at 100 Hz, 10 Hz, 1 Hz, 51 Hz, 200 Hz, 500 Hz, 1000 Hz rate, a sensor update rate, etc.) and/or situation dependent. Each of the matrix R coefficients may thus be viewed and/or processed individually and/or in aggregate as a discrete time signal.

A rotation matrix R may, for example, be output from one or more system modules that integrate information from various sensors (e.g., acceleration sensors, gyroscopes, compasses, pressure sensors, etc.) to ascertain the present orientation of a device. Such a rotation matrix R may, for example in various implementations, be derived from quaternion processing.

In an example implementation, also discussed elsewhere herein, a Direction Cosine Matrix (DCM) module may receive orientation information as input, for example quaternion information and/or Euler angle information from a sensor fusion module, and process such input orientation information to determine the rotation matrix R. In an example implementation, the DCM module may receive quaternion information that is updated at a sensor rate (or sensor sample rate), for example 51 Hz or a different rate less than or greater than 51 Hz. In an example implementation, the DCM module may, however, determine the rotation matrix R at a rate that is equal to a user step rate, a multiple of the user step rate, a fraction of the user step rate, some other function of the user step rate, etc. In other words, the DCM module may determine the rotation matrix R at a rate that is less than the update rate of the information (e.g., orientation information) input to the DCM module. For example, in an example implementation, the DCM module may determine the rotation matrix R only when a step has been detected and/or suspected. Thus, when no stepping is detected, no updating of the rotation matrix R occurs. Though the DCM module is not specifically illustrated in the attached figures, the R coefficients of the rotation matrix R may generally be determined by a DCM module. The DCM module may, for example, be a component of the Attitude Determination Modules discussed herein.

Analyzing the values of the rotation matrix R coefficients, for example as they change over time and/or instantaneously, provides insight into how a user device is positioned, for example providing insight into how a user is utilizing the device. Such analysis may, for example, result in a determined device position (e.g., in relation to the user thereof).

For illustrative simplicity, the following discussion will address analyzing various rotation matrix R coefficients over time, for example discrete time signals, to determine device position, for example to classify the device position by one of a finite set of position classifications. The scope of this disclosure is not, however, limited to a particular number of coefficients being analyzed and/or the manner in which a discrete time signal associated with a particular one or more coefficients is analyzed.

Additionally for example, though the following discussion will generally address analyzing rotation matrix coefficients, other signals indicative of orientation may similarly be analyzed, for example, raw sensor data, motion data, sensor data transformed to the world coordinate system, etc. The analysis of rotational matrix coefficients generally disclosed herein is presented for illustrative convenience and clarity, but the scope of various aspects of this disclosure should not be limited thereby.

Various aspects of this disclosure refer to a body coordinate system and a world coordinate system. Unless identified more specifically, references to the body coordinate system include a device coordinate system, a component or package coordinate system, a chip coordinate system, a sensor coordinate system, etc. The world coordinate system may also be referred to herein as an inertial coordinate system.

Empirical evidence has shown a correlation between various signal characteristics (e.g., rotational matrix coefficients over time) and device position. For example, through observation of mobile telephone utilization and rotation matrix coefficients behavior over time, it has been determined that the rotation matrix coefficient R₃₂, which as explained above is indicative of the degree of alignment between the y-axis of the body coordinate system and the z-axis of the world coordinate system, includes information that is highly indicative of device position, for example as a user moves with the device. Similarly, the coefficient R₃₃ has been found to include useful information, along with R₃₁. The following discussion focuses on analysis of the R₃₂ and R₃₃ coefficients, but the scope of this disclosure is not limited to the analysis of such coefficients.

Various aspects of this disclosure will now be presented by discussion of additional example systems. It should be noted that the systems herein are presented for illustrative clarity and convenience, and the scope of this disclosure should not be limited by any particular characteristics of the example(s) presented herein.

Turning now to FIG. 2A, such figure shows an example signal plot, in accordance with various aspects of this disclosure. For example, FIG. 2A shows an example function of y1=R₃₂(t) as it may look when a device (e.g., a mobile telephone) is held in a hand freely swinging at the user's side while the user is walking. In practice, the function will generally be a discrete time function Y1=R₃₂(nT), but the general idea remains the same. The scope of the present disclosure should not be limited by characteristics of analog and/or digital implementations. The fundamental frequency of y1 may, for example, be generally aligned with the cadence of the user, with each period or complete cycle corresponding to two user steps. As shown, y1 is generally smooth, for example including a relatively small amount of significant higher frequency components (e.g. signal energy at frequencies higher than the fundamental frequency). Contextually, this may for example correspond to a relatively smooth arm swing by a user that is walking.

Turning now to FIG. 2B, such figure shows an example signal plot, in accordance with various aspects of this disclosure. For example, FIG. 2B shows a function of y2=R₃₂(t) as it may look when a device (e.g., a mobile telephone) is positioned in the user's pocket while the user is walking. In practice, the function will generally be a discrete time function Y2=R₃₂(nT), but the general idea remains the same. The fundamental frequency of y2 may, for example, be generally aligned with the cadence of the user, with each period or complete cycle corresponding to two user steps. As shown, y2 has similar energy at the fundamental frequency to y1 of FIG. 2A. Also, as shown, y2 has more fluctuation than y1 of FIG. 2A. This may, for example, be caused by relatively higher amounts of jostling for a device positioned in a pocket compared to a device held in a swinging hand. Signal y2 may, for example, be viewed as having a substantial amount of energy at frequencies higher than the fundamental frequency.

Turning now to FIG. 2C, such figure shows an example signal plot, in accordance with various aspects of this disclosure. For example, FIG. 2C shows a function of y3=R₃₂(t) as it may look when a user is holding a device (e.g., a mobile telephone) out in front of the user's body, for example while interacting with a display of the device. In practice, the function will generally be a discrete time function Y3=R₃₂(nT), but the general idea remains the same. The fundamental frequency of y3 is generally aligned with the cadence of the user, with each period or complete cycle corresponding to two user steps but may also in various use scenarios have a substantial frequency component at the single-step cadence (e.g., depending on how the device is being held by the user). As shown, y3 has substantially less energy at the fundamental frequency than y2 shown in FIG. 2B or y1 shown in FIG. 2A. For example, the amount of device motion in the held-in-front scenario may be less than the respective amounts of motion in the hand-swinging and/or in-pocket scenarios. Also, as shown, y3 has more fluctuation than y1, and for example a similar amount of fluctuation to y2. This may, for example, be caused by relatively higher amounts of jostling for a device being held in front of the user than for a device held in a swinging hand. Signal y3 may, for example, be viewed as having a substantial amount of energy at frequencies higher than the fundamental frequency.

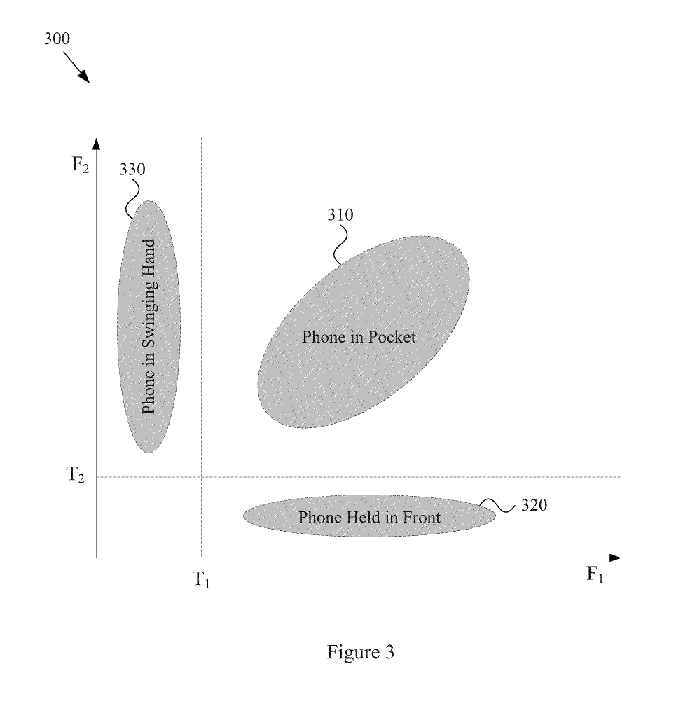

Turning next to FIG. 3, such figure shows a chart 300 of two signal processing results, which may also be referred to herein as features or functions, in accordance with various aspects of the present disclosure. The chart 300 generally shows empirical results, for example regions of scatter plot results obtain through experimentation. At a high level, the F₁ feature shown on the horizontal axis of the chart 300 is a reflection of the presence of substantial higher frequency content (e.g., substantial frequency content at frequencies higher than user stepping frequencies, for example higher than the primary frequency of the plots shown in FIGS. 2A-2C) in a rotation matrix signal (e.g., the R₃₂ signal). For example, it is seen from FIG. 3 that a mobile phone (or other device) positioned in a user's pocket while the user is walking (e.g., shown at region 310) or held by the user in front of the user while the user is walking (e.g., shown at region 320) experiences more substantial higher frequency movement (e.g., jostling) than a phone that is held in the user's hand during typical walking with the user's hand swinging naturally (e.g., shown at region 330). From such empirical results, a threshold T₁ can be set, below which a phone can be determined to be held in a swinging hand, and above which the phone may be determined to be either in the pocket of the user or held by the user in front of the user.

At a high level, the F₂ feature shown on the vertical axis of the chart 300 is a reflection of signal amplitude in one or more rotation matrix signals (for example, the R₃₂ signal, the R₃₃ signal, the combined amplitude of the R₃₂ and R₃₃ signals, etc.). For example, it is seen from FIG. 3 that a mobile phone (or other device) positioned in a user's pocket while the user is walking (e.g., shown at region 310) or held in the user's hand during typical walking with the user's hand swinging naturally (e.g., shown at region 330) experiences higher amounts of movement than a phone that the user is holding in front of the user while walking (e.g., shown at region 320). From such empirical results, a threshold T₂ can be set, below which a phone may be determined to be held by the user in front of the user while the user is walking, and above which the phone may be determined to be either in the user's pocket or held in the swinging hand of the user.

Though FIG. 3 only shows three position classifications, more may be added without departing from the scope of this disclosure. For example, one or more additional regions of the chart 300 may empirically be found to correspond to a device being positioned in a fanny pack, a device carried in an arm or leg band, in a stocking, in a pair of glasses, in a backpack, etc.

Additionally note that there may be confidence regions defined on the chart 300 that are associated with a degree of certainty that a device falls into one of the categories. For example, an F₁/F₂ result that falls within a particular distance of either T₁ and/or T₂ may be associated with less certainty than a result that is at least a particular distance away from such thresholds. For example, such certainty thresholds may be offset from the T₁ and/or T₂ values by an absolute value (e.g. T₁+/−C₁), by a relative value (e.g., T₁+/−C₁%), etc. Graphically, such thresholds may be viewed as horizontal lines above and below the T₂ line and vertical lines to the left and right of the T₁ line of FIG. 3.

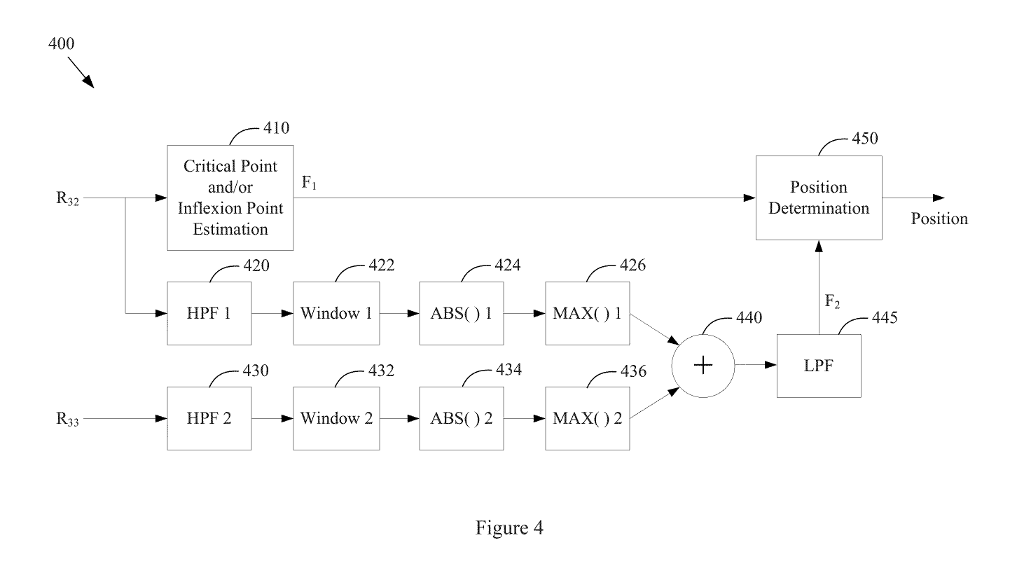

Turning next to FIG. 4, such figure shows an example processing system 400 for determining (or classifying) a position of a device, in accordance with various aspects of the present disclosure. Any or all aspects of the example processing system 400 may, for example, share any or all characteristics with the example device 100 illustrated in FIG. 1 and discussed herein (for example, implemented by a position classification module). As mentioned herein, the F₁ feature is a reflection of higher order frequency content in a signal. In FIG. 4, the Critical Point and/or Inflexion Point Estimation (CPIPE) module 410 processes the input signal (e.g., the R₃₂ rotation matrix coefficient as may, for example be received from a DCM module) over time and outputs the signal F₁, which is an indication of the amount of higher order frequency content in the input signal. The CPIPE module 410 may perform such processing in any of a variety of manners, non-limiting examples of which may comprise determining a number of maxima and/or minima of a signal over a period of time (for example, critical points where the first derivative is zero), determining a number of inflexion points over a period of time (for example, points where the curvature changes between convex and concave or at which the second derivative of the signal changes sign), etc. In such a manner, the number of critical and/or inflexion points during a time window may be indicative of an amount of higher order frequency content. Note that the CPIPE module 410 may, for example, comprise a low pass filter to filter out noise.

As mentioned herein, the F₂ feature is a reflection of signal amplitude. In the example shown in FIG. 4, processing the R₃₂ signal, a first High-Pass Filter (HPF) module 420 with a low cut-off frequency (e.g., 0.1 Hz) is used to remove the DC bias of the R₃₂ signal (e.g., that reflective of steady state orientation).

After being processed by the first HPF module 420, the signal is provided to a first Window module 422 that windows the signal. The window may, for example, comprise static sequential blocks of time, rolling blocks of time, etc. For example, the window may be two seconds in duration, but may also be more or less than two seconds. The duration of the window may also be adjustable during system operation. Note that there are many ways to window a signal. The scope of this disclosure is not limited by characteristics of any particular manner of windowing a signal.

After being processed by the first Window module 422, the signal is provided to a first ABS module 424. The first ABS module 424 may, for example, determine and output a signal indicative of the amplitude of the signal (e.g., exactly equal to the amplitude, indicative of the amplitude of the signal scaled or squared, etc.). Note that there are many ways to determine an amplitude of a signal. The scope of this disclosure is not limited by characteristics of any particular manner of determining an amplitude of a signal.

After being processed by the first ABS module 424, the signal is provided to a first MAX module 426. The first MAX module 426 may, for example, identify a maximum magnitude of the signal (e.g., over the window). Note that there are many ways to determine a maximum amplitude of a signal. The scope of this disclosure is not limited by characteristics of any particular manner of determining a maximum amplitude of a signal.

Similarly, the signal R₃₃ is processed by a second HPF module 430, a second Window module 432, a second ABS module 434, and a second MAX module 436 to identify its maximum amplitude, for example during a time window. Such “second” modules (e.g., 430, 432, 434, and 436) may share any or all characteristics with the “first” modules (e.g., 420, 422, 424, and 426) discussed herein. In an example implementation, the “first” and “second” modules may be performed by same respective modules. For example, an HPF module may process both R₃₂ and R₃₃ (e.g., in a time-multiplexed manner). The “first” and “second” modules may also, for example, be performed by separate distinct modules, for example providing enhanced parallelism for processing.

Since empirical studies have shown that observing the amplitudes of multiple signals may be beneficial, the system 400 illustrated in FIG. 4 adds the maximum amplitudes of the R₃₂ and R₃₃ signals with a Summer module 440. The sum is then low-pass filtered with an LPF module 445 (e.g., with a cutoff frequency of 0.8 Hz or other value greater or less than 0.8 Hz), for example to reduce the instantaneous effects of anomalies, to generate the F₂ feature. As discussed above, the F₂ feature may, for example, comprise an indication of movement magnitude.

Lastly, the Position Determination module 450 analyzes the F₁ and F₂ features (or signals representative thereof), for example comparing such signals with the thresholds T₁ and T₂ discussed with regard to the chart of FIG. 3, to determine (or classify) the position of the device. For example, the Position Determination module 450 may output a signal indicating whether a user is walking (or otherwise moving) with the user device (e.g., a mobile phone) in the user's swinging hand, in the user's pocket, being held in front of the user, etc. The Position Determination module 450 may, for example, communicate the output signal to an operating system, host processor, etc., of a device incorporating the system 400. As discussed previously, the Position Determination module 450 may also determine a confidence level associated with the position classification (e.g., by comparing the features with respective confidence thresholds on either side of the thresholds T₁ and T₂.

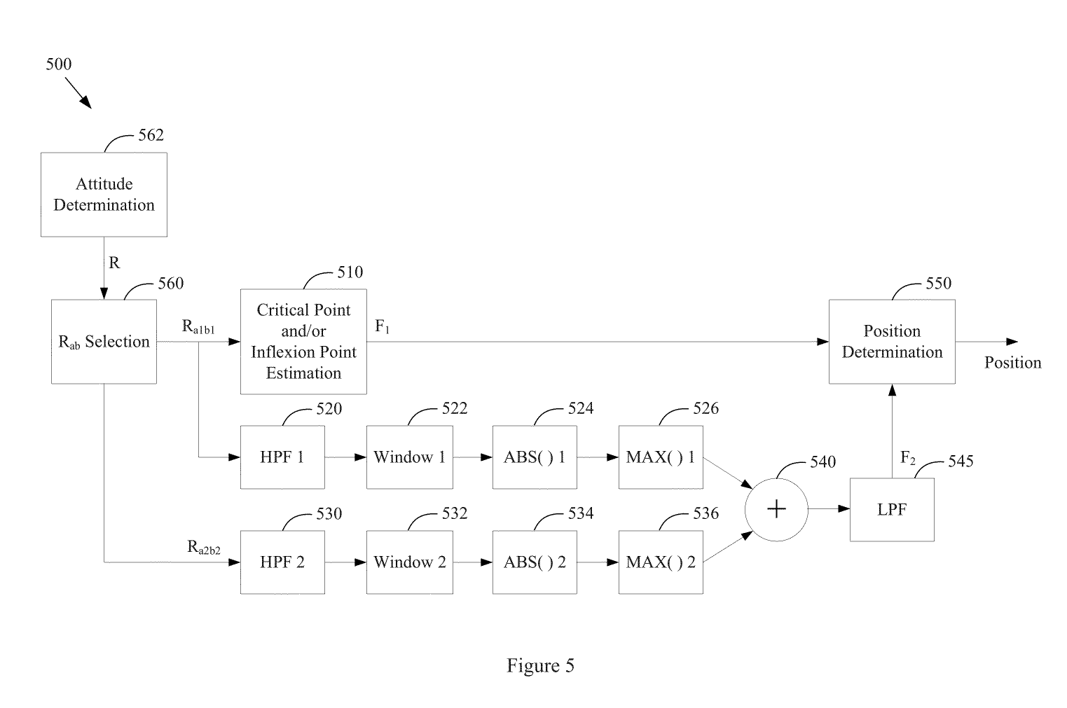

The empirical analysis discussed above included particular device (or phone) use scenarios. A user may also, for example, hold or carry a device in a non-typical manner (e.g., a non-typical orientation in the hand, sideways versus upright, sideways or angled in a pocket instead of upright, etc.). Depending on the orientation and/or general movement of the device, particular signals may have relatively more or more reliable information than other signals. As an example, depending on the usage scenario, the R₃₁ signal may have more useful characteristics (e.g., amplitude, higher frequency energy, and/or noise characteristics) than the R₃₂ signal. In such a scenario, it may be beneficial to have the system 400 flexibly select signals to analyze, for example to select one or more particular rotation matrix coefficients to analyze. FIG. 5 shows an example system 500 like that of FIG. 4, but with a R_{ab} Selection module 560 to select the rotation matrix coefficients to be analyzed by the system 500.

Turning next to FIG. 5, such figure shows an example processing system 500 for determining a position of a device, for example incorporating signal selection, in accordance with various aspects of the present disclosure. The system 500 may, for example, share any or all characteristics with the systems 100 and 400 discussed with regard to FIGS. 1 and 4, and/or with any systems discussed herein. For example, the HPF modules 520 and 530, Window modules 522 and 532, ABS modules 524 and 534, MAX modules 526 and 536, Summer module 541, LPF module 545, CPIPE module 510, and/or Position Determination module 550 may share any or all characteristics with other similarly-named modules discussed herein. Note that also, in various implementations, such modules may have different respective operating parameters.

The R_{ab} Selection module 560 may, for example, receive a plurality (e.g., some or all) of rotation matrix coefficients as input. An example source of such coefficients is shown as an Attitude Determination module 562. As discussed herein, the Attitude Determination module 562 may comprise a DCM module that forms a rotation matrix based, for example, on various sensor signals. As mentioned herein, signal selection may be based at least in part on characteristics of the selected signals themselves (e.g., amplitude or energy levels, frequency content, noise content, etc.), on external sources of information (e.g., information from the operating system regarding how the device is currently being utilized, information from non-inertial sensors like light sensors, microphones, thermometers, etc.). For example, the R_{ab} Selection module 560 may select for analysis the R_{a1b1} signal as the signal of R₃₂ or R₃₁ with the highest energy, or may select both signals. Focusing the signal analysis on dominant signals may, for example, reduce instances of an incorrect position determination.

Also for example, the R_{ab} Selection module 560 may select for analysis the R_{a2b2} signal as the signal of R₃₃ or another signal (e.g., regarding rotation matrix coefficients and/or other parameters) with the highest energy. Again, focusing the signal analysis on dominant signals may, for example, reduce instances of an incorrect position determination. Though only two signals are shown analyzed by the system 500, note that any number of signals may be analyzed, for example if found to be significant by the R_{ab} Selection module 560.

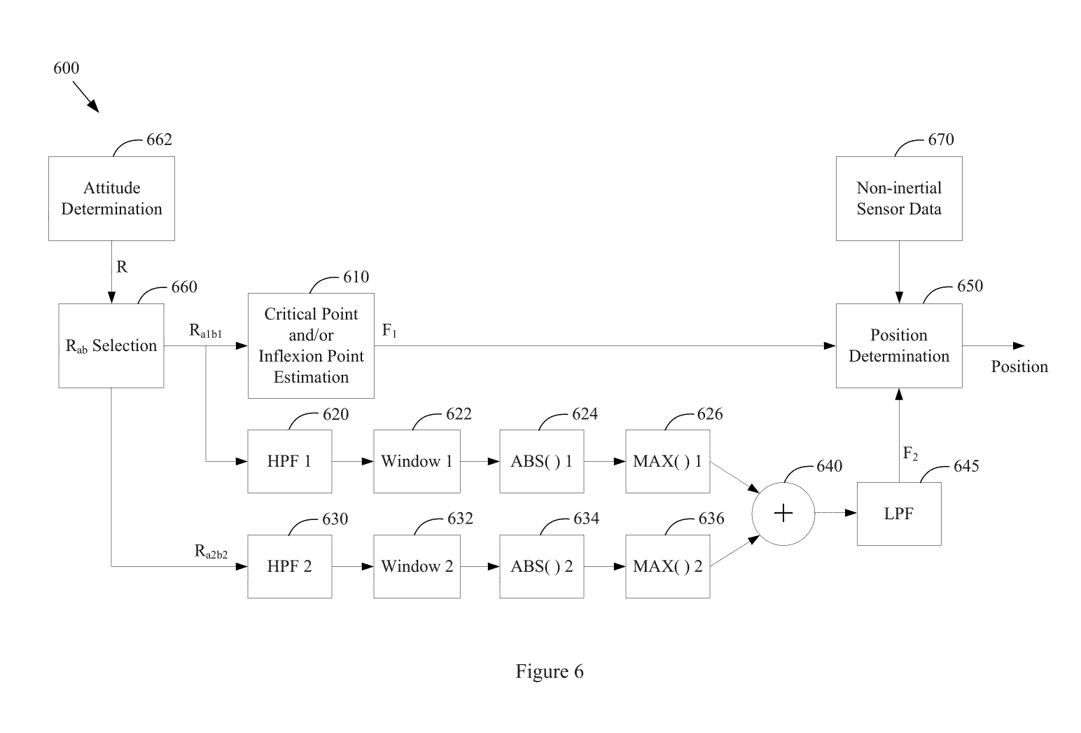

As mentioned herein, the system 500 may classify the device position by processing rotation matrix coefficients. Information from any of a variety of sensors and/or the operating system may be analyzed instead of or in addition to the rotation matrix coefficients. FIG. 6 shows an example system 600 like that of FIG. 5, but with a Non-inertial Sensor Data module 670 added as a source of information gathered from non-inertial sensors.

Turning next to FIG. 6, such figure shows an example processing system 600 for determining a position of a device, for example incorporating non-inertial sensor data, in accordance with various aspects of the present disclosure. The system 600 may, for example, share any or all characteristics with the systems 100, 400 and 500 discussed with regard to FIGS. 1, 4 and 5, and/or with any systems discussed herein. For example, the HPF modules 620 and 630, Window modules 622 and 632, ABS modules 624 and 634, MAX modules 626 and 636, Summer module 641, LPF module 645, CPIPE module 610, Position Determination module 660, Attitude Determination module 662, and/or R_{ab} Selection module 660 may share any or all characteristics with other similarly-named modules discussed herein. Note that also, in various implementations, such modules may have different respective operating parameters.

The Non-inertial Sensor Data module 670 may, for example, receive and/or condition signals from one or more of a variety of non-inertial sensors. Example non-inertial sensors may, for example, comprise light sensors, microphones, pressure sensors, biometric sensors, temperature sensors, moisture sensors, clocks, compasses, magnetometers, etc. The Position Determination module 650 may use this additional information to classify the device position. For example, a light sensor may detect relatively low levels of light when in a user's pocket and/or different frequency content based on whether it is swinging or being held mostly stationary. Also for example, a sound sensor may hear different sounds and/or sound characteristics when stored in a user's pocket, when held in the user's hand, when held with two hands, etc. For example, a pocket location will detect fabric noise and/or muffled ambient noise, while a hand-held position will hear less fabric noise and brighter ambient noise. Further for example, a biometric sensor may have little or no signals in a pocket, a medium-quality signal when held in a single hand, a strong signal when held with both hands, etc. Additionally for example, a temperature sensor may detect elevated temperatures when being held in a hand and/or when being exposed to sunlight, as apposed to being carried in a pocket.

In such scenarios, the Position Determination module 650 may utilize information from such sensors (or from the device O/S, or other source) to augment and/or replace the analysis performed based on rotational matrix coefficients. Such augmentation may be particularly beneficial when a level of certainty in a classification based only on rotation matrix coefficients is relatively low. For example, when relatively uncertain whether a phone is in a pocket or being held by a user, a temperature increase due to the phone being held in the hand and/or exposed to sunlight would support a “hand-held” classification decision. In an example scenario in which the analysis of various sensor signals result in a solution in which the system 600 (e.g., the Position Determination module 650) is confident, other sensors may be shut down, placed into a power-save mode, etc.

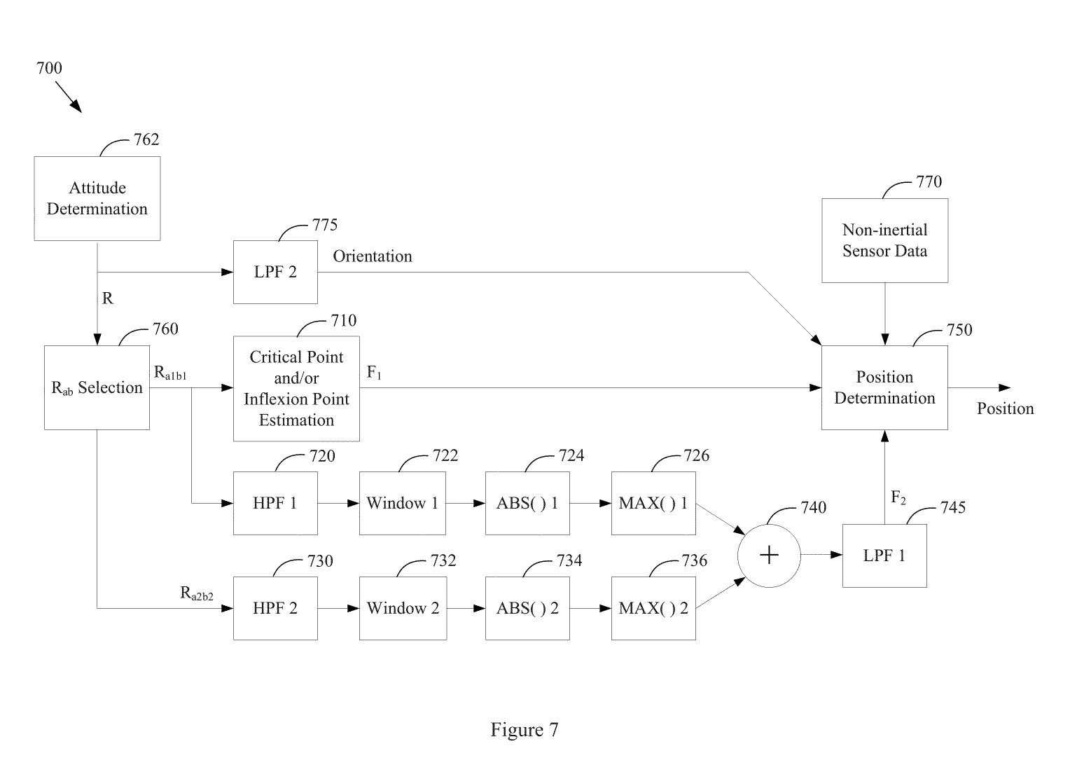

As discussed herein, high-pass filters may be utilized to filter out steady state (or DC) bias from the signals being analyzed. In some instances, the bias information, which may be indicative of steady state device orientation, may be beneficial in determining device position. For example, in a scenario in which a phone held in front of a user is generally held at an average angle of 45°, information of such average orientation may assist the Position Determination module 650 in determining that a phone is being held in front of the user. Similarly, in a scenario in which a phone held in the user's pocket is vertical on-average, information of such average vertical orientation may assist the Position Determination module 650 in determining that the phone is presently located in the user's pocket. Similarly, in a scenario in which a phone held in the user's hand at the user's side is horizontal on-average, information of such average horizontal orientation may assist the Position Determination module 650 in determining that the phone is presently located in the user's hand at the user's side. FIG. 7 shows a system 700 that is generally analogous to the FIG. 6 system, but with a second Low-Pass Filter (LPF) module 775 coupling one or more coefficients of the rotation matrix R to the Position Determination block 750.

In general, FIG. 7 shows an example processing system for determining a position of a device, for example incorporating orientation, in accordance with various aspects of the present disclosure. The system 700 may, for example, share any or all characteristics with the systems 100, 400, 500, and 600 discussed with regard to FIGS. 1, 4, 5, and 6, and/or with any systems discussed herein. For example, the HPF modules 720 and 730, Window modules 722 and 732, ABS modules 724 and 734, MAX modules 726 and 736, Summer module 741, LPF module 745, CPIPE module 710, Position Determination module 760, Attitude Determination module 762, R_{ab} Selection module 760, and Non-inertial Sensor Data module 770 may share any or all characteristics with other similarly-named modules discussed herein. Note that also, in various implementations, such modules may have different respective operating parameters.

The second LPF module 775 low-pass filters one or more coefficients of the rotation matrix R to, for example, provide an indication of steady-state orientation to the Position Determination module 750.

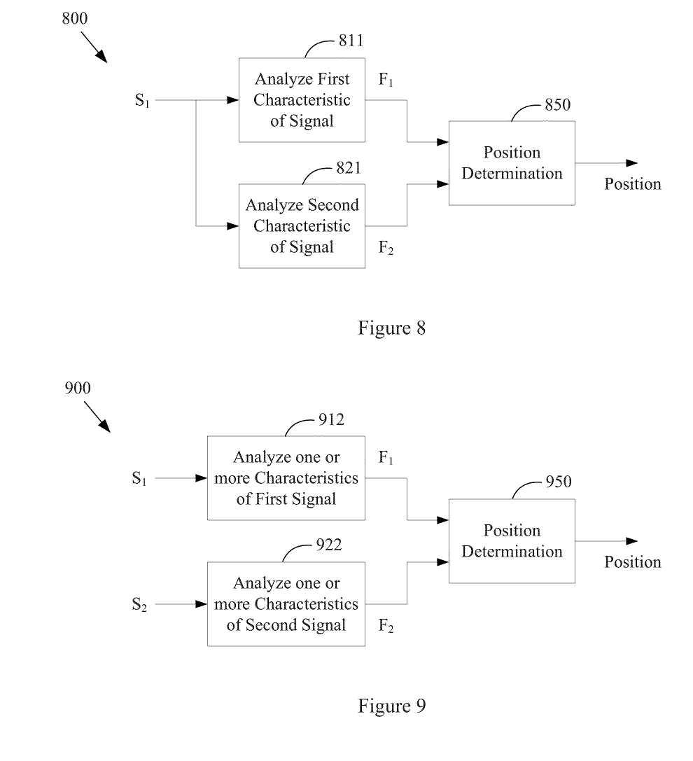

The previous discussion of various systems presented a detailed description of such systems. The scope of various aspects of this disclosure is not, however, limited to the details discussed previously. For example, FIGS. 8-13 present various high-level system diagrams for the illustration of various general aspects of this disclosure, for example both structure and/or functional aspects.

Referring to FIG. 8, such figure shows a system 800 in which different characteristics of a same signal are analyzed to determine (or classify) device position. For example, input signal S₁ may be a discrete time signal (or series) of rotation matrix coefficient values (e.g., for coefficient R₃₂), but need not be. The system 800 may, for example at the First Characteristic Analysis module 811, analyze a first characteristic of the input signal S₁ (e.g., the presence of absence of substantial higher level frequency components) and output the results of such analysis at F₁, and the system 800 may also, for example at the Second Characteristic Analysis module 821 analyze a second characteristic of the input signal S₁ (e.g., maximum amplitude value in a time window) and output the results of such analysis at F₂. The Position Determination module 850 may, as discussed previously, then analyze the F₁ and F₂ signals to classify device position, for example in a manner generally analogous to the manners discussed elsewhere herein.

Referring next to FIG. 9, such figure shows a system 900 in which same or different respective characteristics of different respective signals are analyzed to determine (or classify) device position. For example, input signal S₁ may be a discrete time signal (or series) of rotation matrix coefficient values (e.g., for coefficient R₃₂), but need not be. Similarly, input signal S₂ may be a discrete time signal (or series) of rotation matrix coefficient values (e.g., for coefficient R₃₃), but need not be. For example, both input signals S₁ and S₂ may be related to inertial sensors. Also for example, one of such input signals may be related to inertial sensors and the other related to a non-inertial sensor. Additionally for example, both of such input signals may be related to non-inertial sensors. Input signal S₁ may, for example, be analyzed by the First Signal Analysis module 912 for one or more of a variety of signal characteristics, various non-limiting examples are presented herein (e.g., higher frequency content, amplitude, bias, etc.). Input signal S₂ may, for example, be analyzed by the Second Signal Analysis module 922 for one or more of a variety of signal characteristics, various non-limiting examples are presented herein (e.g., higher frequency content, amplitude, bias, etc.). The Position Determination module 950 may then process the results of such signal analysis to determine or classify the device position.

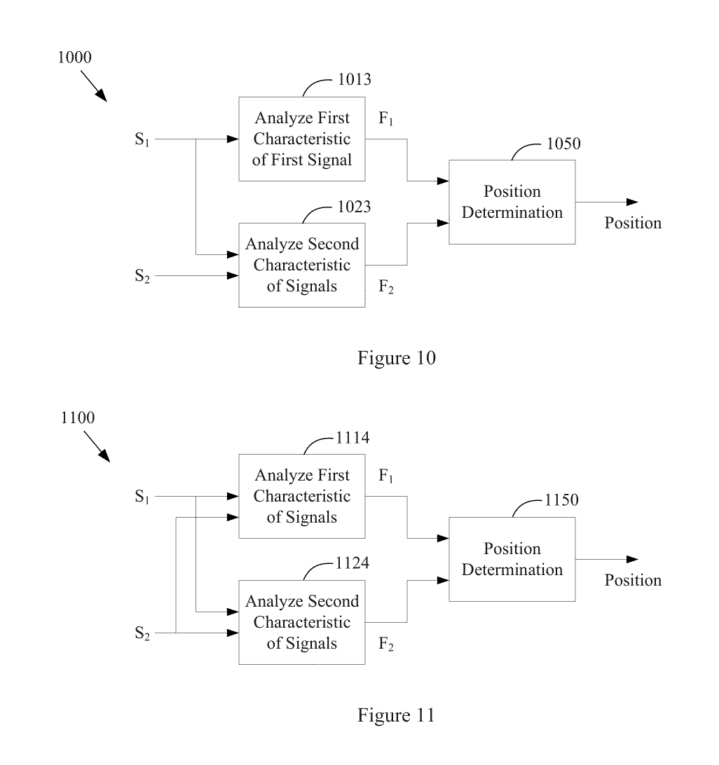

Referring now to FIG. 10, such figure shows a system 1000 in which a first characteristic of a first signal is analyzed, a second characteristic of the first signal and of a second signal is analyzed, and the results of such analyses are processed to classify device position. For example, input signal S₁ may be a discrete time signal (or series) of rotation matrix coefficient values (e.g., for coefficient R₃₂), but need not be. The system 1000 may, for example at the First Signal Analysis Module 1013, analyze a first characteristic of the input signal S₁ (e.g., the presence of absence of substantial higher level frequency components) and output the results of such analysis at F₁. Also for example, input signal S₂ may be a discrete time signal (or series) of rotation matrix coefficient values (e.g., for a coefficient R₃₃), but need not be. The system 1000 may also, for example at the Second Signal Analysis Module 1023, analyze a second characteristic of the input signals S₁ and S₂ (e.g., maximum combined amplitude value in a time window) and output the results of such analysis at F₂. The Position Determination module 1050 may, as discussed previously, then analyze the F₁ and F₂ signals to classify device position, for example in a manner generally analogous to the manners discussed elsewhere herein.

Referring next to FIG. 11, such figure shows a system 1100 similar to the system 1000 of FIG. 10, but with the first characteristic (e.g., a frequency content characteristic) of the second signal S₂ also being analyzed. For example, input signal S₁ may be a discrete time signal (or series) of rotation matrix coefficient values (e.g., for coefficient R₃₂), but need not be. The system 1000 may, for example at the First Signal Analysis Module 1114, analyze a first characteristic of the input signals S₁ and S₂ (e.g., the presence of absence of substantial higher level frequency components) and output the results of such analysis at F₁. Also for example, input signal S₂ may be a discrete time signal (or series) of rotation matrix coefficient values (e.g., for a coefficient R₃₃), but need not be. The system 1100 may also, for example at the Second Signal Analysis Module 1124, analyze a second characteristic of the input signals S₁ and S₂ (e.g., maximum combined amplitude value in a time window) and output the results of such analysis at F₂. The Position Determination module 1150 may, as discussed previously, then analyze the F₁ and F₂ signals to classify device position, for example in a manner generally analogous to the manners discussed elsewhere herein.

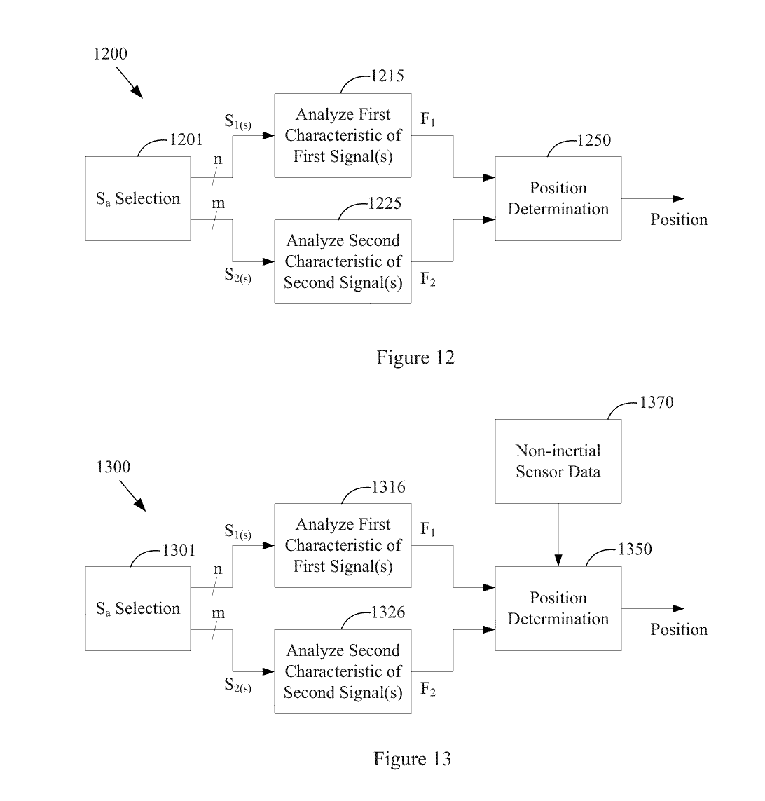

Referring to FIG. 12, as discussed herein the signals to be analyzed may, for example at the Signal Selection module 1201 be selected (e.g., at startup, during real-time as the device is used, etc.) for processing. For example, in a first use scenario a first set of n (e.g., one or more) signals may be analyzed, for example at the First Signal Analysis Module 1215, for a first signal characteristic (e.g., a frequency or spectral content characteristics) and a second set of m (e.g., one or more) signals may be analyzed, for example at the Second Signal Analysis Module 1225 for a second signal characteristic (e.g., an amplitude characteristics). A second use scenario may, for example, result in one or more different sets of signals being analyzed. For example, a general device orientation may change, causing the Signal Selection module 1201 to select different signals associated with different rotation directions, different inertial or non-inertial sensors, etc. The Position Determination module 1250 may, as discussed previously, then analyze the F₁ and F₂ signals to classify device position, for example in a manner generally analogous to the manners discussed elsewhere herein.

Referring to FIG. 13, such figure shows a system 1300 that is generally similar to the system 1200 shown in FIG. 12, but with the addition of a Non-inertial Sensor Data module 1370 providing information directly to the Position Determination module 1350. Such a system configuration is not meant to exclude non-inertial sensor information from being selected and processed to obtain features F₁ and F₂. The signals to be analyzed may, for example at the Signal Selection module 1301 be selected (e.g., at startup, during real-time as the device is used, etc.) for processing. For example, in a first use scenario a first set of n (e.g., one or more) signals may be analyzed, for example at the First Signal Analysis Module 1316, for a first signal characteristic (e.g., a frequency or spectral content characteristics) and a second set of m (e.g., one or more) signals may be analyzed, for example at the Second Signal Analysis Module 1326 for a second signal characteristic (e.g., an amplitude characteristics). A second use scenario may, for example, result in one or more different sets of signals being analyzed. For example, a general device orientation may change, causing the Signal Selection module 1301 to select different signals associated with different rotation directions, different inertial or non-inertial sensors, etc. The Position Determination module 1250 may, as discussed previously, then analyze the F₁ and F₂ signals, along with the data from the Non-inertial Sensor Data module 1370, to classify device position, for example in a manner generally analogous to the manners discussed elsewhere herein.

The systems illustrated in FIGS. 1 and 4-13 were presented to illustrate various aspects of the disclosure. Any of the systems presented herein may share any or all characteristics with any of the other systems presented herein. Additionally, it should be understood that the various modules were separated out for the purpose of illustrative clarity, and that the scope of various aspects of this disclosure should not be limited by arbitrary boundaries between modules. For example, any one or more of the modules may share hardware and/or software with any one or more other modules.

As discussed herein, any one or more of the modules and/or functions discussed herein may be implemented by a pure hardware solution or by a processor (e.g., an application or host processor, a sensor processor, etc.) executing software instructions. Similarly, other embodiments may comprise or provide a non-transitory computer readable medium and/or storage medium, and/or a non-transitory machine readable medium and/or storage medium, having stored thereon, a machine code and/or a computer program having at least one code section executable by a machine and/or a computer (or processor), thereby causing the machine and/or computer to perform the methods as described herein.

In summary, various aspects of the present disclosure provide a system and method for determining device position (e.g., in relation to a user thereof). While the foregoing has been described with reference to certain aspects and embodiments, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular embodiment(s) disclosed, but that the disclosure will include all embodiments falling within the scope of the appended claims.

1. A system for classifying position of a device, the system comprising:
at least one module operable to, at least:
receive a discrete time signal representation of a rotation matrix coefficient;
analyze a first characteristic of the discrete time signal;
analyze a second characteristic, different from the first characteristic, of the discrete time signal; and
classify the position of the device based, at least in part, on the analysis of the first characteristic and the analysis of the second characteristic.

2. The system of claim 1, wherein:
the discrete time signal is characterized by a fundamental frequency component; and
the first characteristic comprises frequency content of the discrete time signal at higher frequencies than the fundamental frequency component.

3. The system of claim 2, wherein the at least one module is operable to analyze the first characteristic of the discrete time signal by, at least in part, counting at least one of critical points and/or inflection points of the discrete time signal.

4. The system of claim 1, wherein the second characteristic comprises amplitude of the discrete time signal.

5. The system of claim 4, wherein the at least one module is operable to analyze the second characteristic of the discrete time signal by, at least in part, determining a maximum amplitude of the discrete time signal during a window.

6. The system of claim 1, wherein the at least one module is further operable to:
receive a second discrete time signal representation of a second rotation matrix coefficient;
analyze the second characteristic of the second discrete time signal; and
classify the position of the device based further, at least in part, on the analysis of the second characteristic of the second discrete time signal.

7. The system of claim 1, wherein the at least one module is operable to select the rotation matrix coefficient from a plurality of rotation matrix coefficients.

8. The system of claim 1, wherein the at least one module is operable to classify the position of the device based further, at least in part, on non-inertial sensor data.

9. The system of claim 1, wherein the at least one module is operable to classify the position of the device by at least in part selecting the position of the device from a set of positions, the set of positions comprising: device in pocket, device held in front of user, and device held at side of user.

10. The system of claim 1, wherein the rotation matrix coefficient comprises an R₃₂ coefficient.

11. The system of claim 6, wherein:
the rotation matrix coefficient comprises an R₃₂ coefficient; and
the second rotation matrix coefficient comprises an R₃₃ coefficient.

12. A system for classifying position of a device, the system comprising:
at least one module operable to, at least:
analyze a first rotation matrix coefficient over time;
analyze a second rotation matrix coefficient over time; and
classify the position of the device based, at least in part, on the analysis of the first rotation matrix coefficient and the analysis of the second rotation matrix coefficient.

13. The system of claim 12, wherein the at least one module is operable to analyze the first rotation matrix coefficient over time by, at least in part, analyzing frequency content of the first rotation matrix coefficient over time at frequencies above a fundamental frequency of the first rotation matrix coefficient over time.

14. The system of claim 12, wherein the at least one module is operable to analyze the second rotation matrix coefficient over time by, at least in part, analyzing amplitude of the second rotation matrix coefficient over time.

15. The system of claim 12, wherein:
the at least one module is operable to analyze the first rotation matrix coefficient over time by, at least in part:
analyzing frequency content of the first rotation matrix coefficient over time at frequencies above a fundamental frequency of the first rotation matrix coefficient over time; and
analyzing amplitude of the first rotation matrix coefficient over time; and
the at least one module is operable to analyze the second rotation matrix coefficient over time by, at least in part, analyzing amplitude of the second rotation matrix coefficient over time.

16. The system of claim 12, wherein at least one of the first and second rotation matrix coefficients comprises an R₃₂ coefficient.

17. The system of claim 12, wherein at least one of the first and second rotation matrix coefficients comprises an R₃₃ coefficient.

18. A system for classifying position of a device, the system comprising:
at least one module operable to, at least:
receive a signal indicative of orientation of a device;
perform a first analysis of at least a first characteristic of the received signal;
perform a second analysis of at least a second characteristic, different from the first characteristic, of the received signal; and
classify the position of the device based, at least in part, on the first analysis and the second analysis.

19. The system of claim 18, wherein the received signal comprises a fundamental frequency component, and the first analysis comprises analyzing frequency content of the received signal at higher frequencies than the fundamental frequency.

20. The system of claim 18, wherein the second analysis comprises analyzing amplitude of the received signal.

21. The system of claim 18, wherein the at least one module is operable to:
receive a second signal indicative of orientation of the device;
perform a third analysis of at least the second characteristic of the received second signal; and
classify the position of the device based further, at least in part, on the third analysis.

22. The system of claim 18, wherein the received signal comprises a discrete time signal representation of a rotation matrix coefficient.

23. The system of claim 18, wherein the at least one module is operable to select the signal from a plurality of signals.

24. The system of claim 18, wherein the at least one module is operable to classify the position of the device based further, at least in part, on non-inertial sensor data.

25. The system of claim 18, wherein the at least one module is operable to classify the position of the device by at least in part selecting the position from a set of positions, the set of positions comprising: device in pocket, device held in front of user, and device held at side of user.
